(19) United States
(12) Patent Application Publication
(10) Pub. No.: US 2018/0029299 A1
(43) Pub. Date: Feb. 1, 2018

(54) ADDITIVE MANUFACTURING WITH OFFSET STITCHING

(71) Applicant: Stratasys, Inc., Eden Prairie, MN (US)

(72) Inventors: Moshe Aknin, Modi'in-Maccabim-Reut (IL); Jonathan B. Hedlund, Blaine, MN (US); J. Samuel Batchelder, Somers, NY (US)

(21) Appl. No.: 15/553,755

(22) PCT Filed: Feb. 26, 2016
(86) PCT No.: PCT/US2016/019704

§ 371 Date: Aug. 25, 2017

Related U.S. Application Data
(60) Provisional application No. 62/121,013, filed on Feb. 26, 2015.

(51) Int. Cl. B29C 64/393; B33Y 50/02; B33Y 10/00; B29C 64/291; B29C 64/112

(52) U.S. Cl. CPC B29C 64/393; B29C 64/291; B29C 64/112; B33Y 10/00; B33Y 50/02

(57) ABSTRACT

A method of printing a three-dimensional part includes dividing each of a plurality of layers of a model of the three-dimensional part into a plurality of passes, where each of the plurality of passes is separated from one or more adjacent passes by a gap. The gap between passes in a first layer is offset from the gap between passes in an adjacent layer, such that the gap between passes in the first layer does not align with or stack with the gap between passes in the adjacent layer.

### BACKGROUND

This relates generally to three-dimensional printing, and more specifically to printing patterns in a three-dimensional printer.

Additive manufacturing systems, commonly known as three-dimensional (3D) printers, are used to print or otherwise build 3D parts from digital representations of the 3D parts (e.g., STL format files) using one or more additive manufacturing techniques. Examples of commercially available additive manufacturing techniques include extrusion-based techniques, jetting, selective laser sintering, powder/binder jetting, electron-beam melting, digital light processing, and stereolithographic processes. For each of these techniques, the digital representation of the 3D part is initially separated into multiple horizontal layers or slices. A tool path or image is then generated representing each layer or slice, which provides instructions for the particular additive manufacturing system to print the given layer.

For example, in an extrusion-based additive manufacturing system, a 3D part may be printed from a digital representation of the 3D part in a layer-by-layer manner by extruding a flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane) to form a new layer, and the process is then repeated to form a 3D part resembling the digital representation.

In another example, in a stereolithography-based additive manufacturing system, a 3D part is printed from a digital representation of the 3D part in a layer-by-layer manner by projecting light across a vat of photo-curable resin. The projected light in various examples is provided via a projector, such as a DLP (Digital Light Processing) ultraviolet projection image, or is drawn, such as via a laser. For each layer, the projected light provides a light image representing the layer on the surface of the liquid resin, which cures and solidifies the drawn light pattern. After the layer is completed, the system's platform is lowered by a single layer increment. A fresh portion of the resin then recoats the previous layer, and the light is projected across the fresh resin to pattern the next layer, which joins the previous layer. This process is then repeated for each successive layer. Afterwards, the uncured resin may be cleaned, and the resulting 3D part may undergo subsequent curing.

In fabricating 3D parts by these techniques, supporting layers or structures are typically built underneath overhanging portions or in cavities of 3D parts under construction, which are not supported by the part material itself. A support structure may be built utilizing the same techniques by which the 3D part is formed. The host computer in some such examples generates additional geometry acting as a support structure for the overhanging or free-space segments of the 3D part being formed. The support structure adheres to the 3D part during fabrication, and is removable from the completed 3D part when the printing process is complete.

The size and resolution of the 3D part being formed by printing techniques such as these is typically limited by the size of the print apparatus and by the resolution of the print mechanism. For example, a 3D printer having a 12×12×12 working area can produce parts up to 12×12×12, but larger parts would have to be assembled from multiple pieces or fabricated using a larger printer. Similarly, a 3D printer using DLP ultraviolet projection is limited by the resolution of the projection apparatus, and by the area that can be covered by such a projected image. Because 3D print users typically desire high resolution of parts, such as may exceed the resolution of a DLP projection assembly, it is desirable to provide improved resolution while providing a large work area in such systems.

### SUMMARY

One exemplary embodiment comprises a method of printing a three-dimensional part includes dividing each of a plurality of layers of a model of the three-dimensional part into a plurality of passes, where each of the plurality of passes is separated from one or more adjacent passes by a gap. The gap between passes in a first layer is offset from the gap between passes in an adjacent layer, such that the gap between passes in the first layer does not align with or stack with the gap between passes in the adjacent layer.

In a further aspect of the disclosure, each of the plurality of passes and layers are printed by projecting a curing light image via a projector assembly, the curing light image projected through at least part of a top layer and a layer adjacent to the top layer.

In another aspect of the disclosure, the layers comprise a layer material comprising photo-curable resin or photopolymer, and layer material in one or more offset gaps is cured by exposing the one or more offset gaps to curing light through a layer between the one or more offset gaps and the curing light.

The details of one or more examples of the invention are set forth in the accompanying drawings and the description below. Other features and advantages will be apparent from the description and drawings, and from the claims.

### BRIEF DESCRIPTION OF THE DRAWINGS

FIG. 1 shows a 3D DLP projection printer, consistent with the prior art.

FIG. 2 shows a 3D DLP projection printer, consistent with an exemplary embodiment.

FIG. 3 shows a part being printed in a series of overlapping passes using a photo-curable resin, consistent with an exemplary embodiment.

FIG. 4 shows a part being printed in a series of adjacent, non-overlapping passes using a photo-curable resin, consistent with an exemplary embodiment.

FIG. 5 shows a part being printed in a series of adjacent passes separated by a gap using a photo-curable resin, consistent with an exemplary embodiment.

FIG. 6 shows optical curing of photopolymer layers forming a 3D part, consistent with an exemplary embodiment.

FIG. 7 shows selection of a gap position between adjacent passes to avoid a part, consistent with an exemplary embodiment.

FIG. 8 is a flowchart illustrating a method of printing a 3D part using offset gaps, consistent with an exemplary embodiment.

FIG. 9 shows a computerized system operable to control a 3D printer, consistent with an exemplary embodiment.

### DETAILED DESCRIPTION

In the following detailed description, reference is made to specific exemplary embodiments by way of drawings and illustrations. These exemplary embodiments are described in sufficient detail to enable those skilled in the art to practice what is described, and serve to illustrate how elements of this disclosure may be applied to various purposes or embodiments. Other embodiments exist, and logical, mechanical, electrical, and other changes may be made.

Features or limitations of various embodiments described herein, however important to the embodiments in which they are incorporated, do not limit other embodiments, and any reference to the elements, operation, and application of the embodiments serve only to define these embodiments. Features or elements shown in various embodiments described herein can be combined in ways other than shown in the embodiments, and any such combinations is explicitly contemplated to be within the scope of the embodiments presented here. The following detailed description does not, therefore, limit the scope of what is claimed.

A wide variety of 3D printing technologies exist, and are operable to print, build, or otherwise produce 3D parts and/or support structures at least in part using an additive manufacturing technique or system. For example, parts are printed using deposited materials such as thermoplastics in some embodiments, are printed by binding materials such as ceramic or metal particles in some embodiments, and are printed using photolithography such as photo-curable resins in other embodiments. The additive manufacturing system may be a stand-alone unit, a sub-unit of a larger system or production line, and/or may include other non-additive manufacturing features, such as subtractive-manufacturing features, pick-and-place features, two-dimensional printing features, and the like.

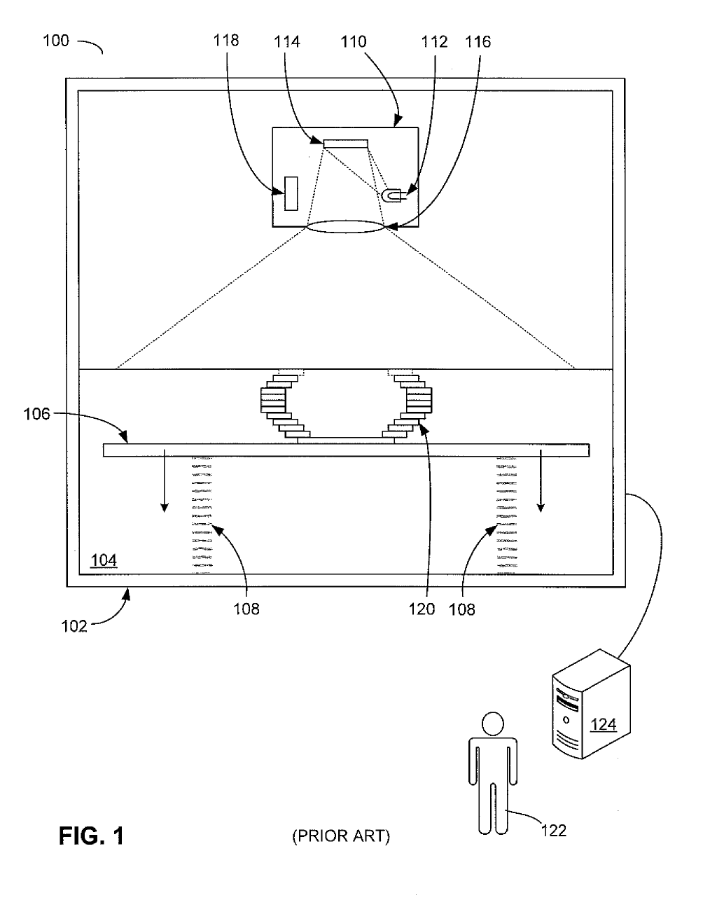

FIG. 1 shows a typical three-dimensional digital light processing (DLP) projection printer, consistent with the prior art. The printer illustrated in FIG. 1 is operable to print a 3D part using an optical-based additive manufacturing method in which a resin vat holds a resin that is cured through exposure to ultraviolet light projected by a DLP projection assembly. After each layer is formed, a platform in the resin vat is adjusted to allow the next layer of resin to be applied and cured. The process is repeated for each successive layer, until the 3D part is completed.

Here, a 3D printer shown generally at 100 includes a work area defined by an enclosure 102, which in this printer includes a vat for resin material 104. The vat includes a work platform 106 that can be raised or lowered, such as via mechanical leadscrews 108. The 3D printer further includes a digital light processing (DLP) projector assembly 110, which includes ultraviolet lamp 112, DLP digital micromirror device (DMD) 114, projection lens 116, and light sink 118. The work table 106 supports a part 120 that is being printed using the 3D printer, such that when leadscrews 103 raise or lower the work table 106 the part 120 is raised or lowered with the work table. In an alternative embodiment, the work table remains stationary, but the level of resin material 104 in the enclosure 102 is raised or lowered to vary the payer being printed by the 3D printer.

A user 122 creates a digital representation of a 3D part to be printed, such as by scanning a 3D part using known methods such as digital photography, laser scanning, or the like, or such as by drawing a 3D part using a computer-aided design (CAD) program. The user loads the digital representation into a computerized system 124, which in this system is a computer that is connected to the digital printer. The computerized system 124 here serves to direct the 3D printer 100 to print the part 120 by operating the DLP projector assembly 110 and work table 106 to print successive layers of the part, and includes in various systems other circuitry configured to monitor or operate various features of 3D printer 100.

In other embodiments, resin 104 is contained in a tank, tray, or other receptacle that is configured to retain a flowable photo-curable resin used to print 3D part 120. Work platform 106 is operable to be raised or lowered (z-axis) via a mechanism such as leadscrews 108, a motor, gear, belt, or other mechanism, and may be further supported by rails, linear bearings, or other such mechanisms (not shown). The DLP projector assembly is mounted above the surface of resin 104, and is operable to project an image onto the resin surface in the x-y plane. Although the projector here projects ultraviolet light using DLP technology, other embodiments will include other types of light, such as visible light, and other projection technologies such as liquid crystal display (LCD) projection.

In operation, the user 122 loads a digital representation of the part to be printed into computerized system 124, which controls operation of the 3D printer 100. The computerized system 124 may include various control circuitry, control software, digitization software, computer-aided manufacturing (CAM) software, interface hardware and software, device drivers, and monitoring/calibration hardware and software to enable computerized system 124 to operate the 3D printer 100.

The computerized system 124 controls the 3D printer 100 to print the part 120 by bringing work platform 106 into position to print the first layer of part 106. This can be achieved by operating motors attached to leadscrews 108, by adjusting the level of resin 104 in the enclosure 102, or by any other suitable method. Once the work table is properly positioned relative to the resin level, the computerized system 124 selectively exposes certain areas of the resin to ultraviolet light by use of DLP projector assembly 110. This is achieved by illuminating UV lamp 112, and configuring DMD (Digital Micromirror Device) 114 to selectively project light through projection lens 116 to form an image on the surface of the resin 104 that represents the resin areas that are to become a part of the first layer or slice of part 120. The DMD 114 projects the image by selectively actuating an array of very small mirrors to either reflect ultraviolet light from ultraviolet lamp 112 through the projection lens 116, or to light sink 118. Exposing the resin to ultraviolet light by selectively actuating the very small mirrors of DMD 114 causes the resin to cure or solidify in the areas exposed to projected ultraviolet light, thereby forming the first part layer.

Once the first layer of part 120 has been exposed to ultraviolet light sufficient to cure the first layer of part 120, the work platform 104 is moved down (in the z-axis) or the level of resin 104 is moved up to provide a fresh layer of uncured resin covering the part 120. The fresh resin is then exposed to a pattern of ultraviolet light using DLP projector assembly 110, causing the next layer of part 120 to cure and attach to the previously cured layers of the part. This process is repeated to form each layer of the part 120, thereby forming a part made up of many layers or slices in the x-y plane.

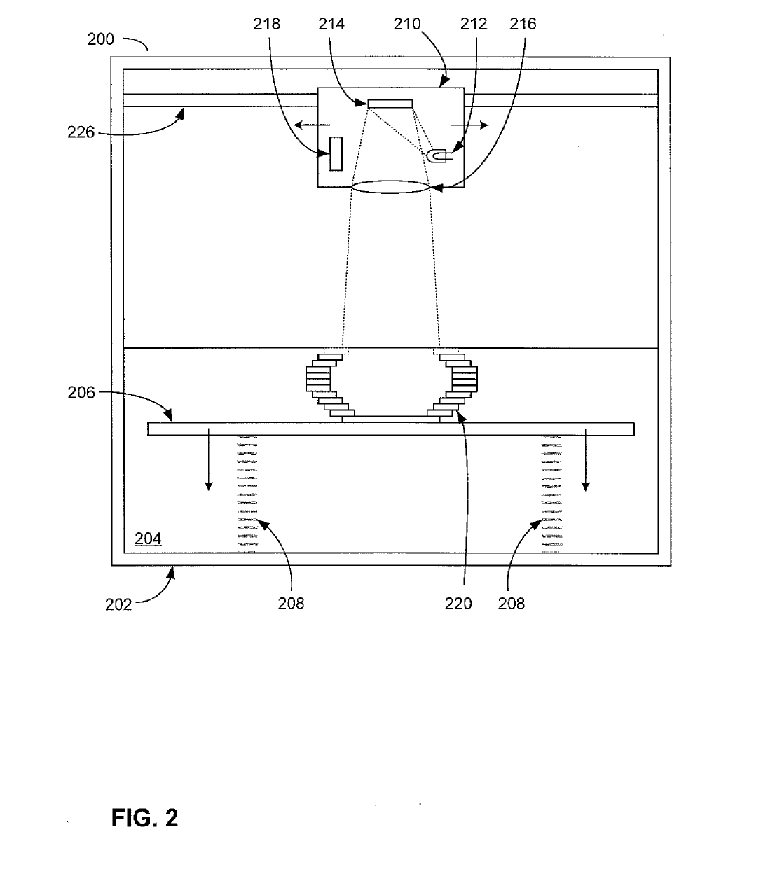

The resolution of the part 120 in the simplified 3D printer configuration of FIG. 1 is therefore determined in the z-axis by the number of individual layers used to make up the part, and by process constraints such as the degree of adjustability of the work platform 106 and the cure sensitivity and depth of resin 104. The resolution of the part 120 is limited in the x-y plane by the resolution of the projector 110, and the practical size of the part 120 and of the useful working space on work platform 106 is limited by the effective projection area of the projector assembly 110. Some embodiments therefore employ a movable projector assembly, operable to project over a wider area or to provide a greater effective resolution, as shown in FIG. 2.

FIG. 2 shows a 3D DLP projection printer having a movable projector, consistent with an exemplary embodiment that is useful in manufacturing parts with an additive manufacturing system that cannot be manufactured with a typical additive manufacturing system as illustrated in FIG. 1 due to the size of the part being printed. If the part size become sufficiently large, a single, stationary DLP projector may not be able to produce the desired resolution or accuracy of the layer being printed. In FIG. 2, 3D printer 200 includes similar features to the printer of FIG. 1, including an enclosure 202 supporting a container of resin 204, a work platform 206 supported by leadscrews 208, and a projector assembly 210 that includes UV lamp 212, digital micromirror device 214, projection lens 216, and light sink 218. The projector operates to build or print a 3D part 220.

The DLP projector assembly 210 is mounted to one or more support rails 226, such that the projector assembly is movable within enclosure 202. This is achieved by use of belts, gears, motors, or other such mechanisms in various embodiments, and enables the projector to be selectively positioned over various parts of the work platform 206 by operation of such a mechanism. The projector is operable to move in one dimension as indicated by the arrows on projector assembly 210, but in other embodiments the projector assembly will be movable in multiple dimensions, such as in the x-y plane corresponding to the surface of resin 204.

This enables the projector assembly 210 to use the entire resolution of the digital micromirror device 214 to print a small portion of the part 220, and to then move location relative to the work platform 206 and part 220 and print another small portion of the part 220. This effectively increases the size and resolution of parts that can be printed relative to the printer 10, and allows a single projector assembly 210 to print over a very large work space with no reduction in resolution or accuracy of the printed part.

But, printing a part 220 with a moving projector assembly 210 can create certain problems not present with a fixed projector assembly, such as ensuring proper position and alignment of the projector assembly 210 as it prints adjacent sections of part 220. Variables such as accuracy, resolution, and repeatability of the mechanism that moves projector assembly 210 on a gantry or rails 226 can contribute to error in positioning the projector relative to the part 220, as can mechanical tolerances such as lash in a positioning mechanism such as gears or leadscrews or stretch in a belt drive mechanism. Further, projected images often include varying types and degrees of distortion, including barrel, pincushion, and moustache distortion, which can become increasingly problematic if inexpensive, low-quality lenses are used in the projection assembly.

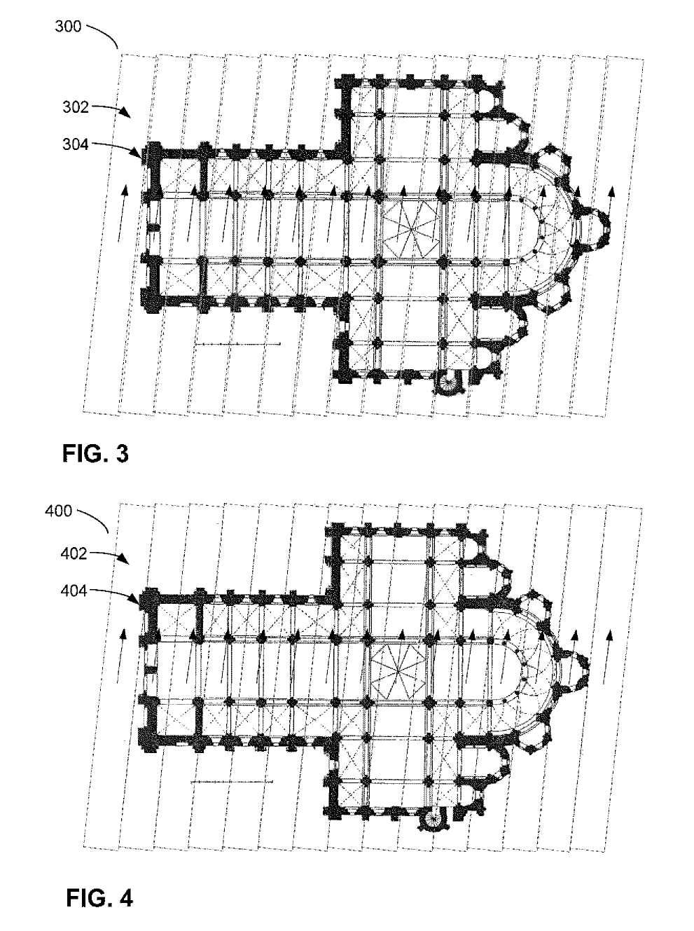

FIG. 3 shows generally at 300 a part 302 being printed in a series of overlapping passes using a photo-curable resin. Here, a series of passes 302 are used to print a part 304, each pass proceeding from bottom to top as shown in the x-y plane. The passes as illustrated are further based on scanning the projector assembly from left to right relative to the work platform, resulting in a pass 302 that appears angled to the right as the projector passes from bottom to top in FIG. 3. In alternate embodiments, an entire pass 302 will be completed before the projector assembly changes position to the right and completes the next pass.

For each pass completed, the projected image changes as the projector assembly moves, resulting in a projected image that appears to remain stationary as projected on the resin surface. The image is shifted across the DLP array synchronously with the motion of the projector assembly 210 so that the image of a particular part feature remains stationary on the part 220 as the head 210 moves. The mirror associated with a particular pixel on the part changes with each frame, such that if the DLP is N pixels wide in the scanning direction, the dose of UV in the vat is the highest for an image pixel if all N mirrors are oriented to expose that image pixel as the head moves by. If fewer mirrors expose the image, the dose is lower. The frame dwell time of an image from the DLP tends to be on the order of 30 Hz*256, or 8 KHz, so that individual pixels can have a 256 bit difference in illumination intensity. For instance, where the projected pixel size is 2 mils, the velocity of the moving projector is 0.002″*8 KHz or 16ips.

Each of the passes 302 shown here overlaps the prior pass to some degree, ensuring that all resin that is intended to form a section of the part 304 is exposed to ultraviolet light and cured during at least one pass of the projector assembly. But, overlapping passes can result in exposing the same section of resin twice, which can cause a part 304 to bloom, or grow larger in the area of double exposure. This reduction of smoothness and detail of parts can be compensated by managing the degree of overlap to a position that is on the order of less than a projected pixel, but this is difficult to achieve and suffers from the same repeatability and accuracy problems as printing adjacent strips. Similarly, the digital micromirror can vary the amount of light projected by certain micromirrors to manage exposure of overlapping areas, such as to cure overlapping areas of resin to a lesser degree than other areas of resin. But, such exposure control again assumes at least pixel-resolution accuracy of the projector, so that areas of the resin are not underexposed or overexposed.

FIG. 4 shows a part being printed in a series of adjacent, non-overlapping passes using a photo-curable resin. As shown generally at 400, each of the passes 402 used to print part 404 are exactly mated, and do not overlap as did the passes 302 of FIG. 3. This allows for uniform exposure from the projector over all areas covered by the pass 402, but again requires better than single pixel resolution in projecting the image immediately adjacent to each prior pass to ensure that the finished part is a solid part without gaps or weak points between sections exposed in adjacent passes.

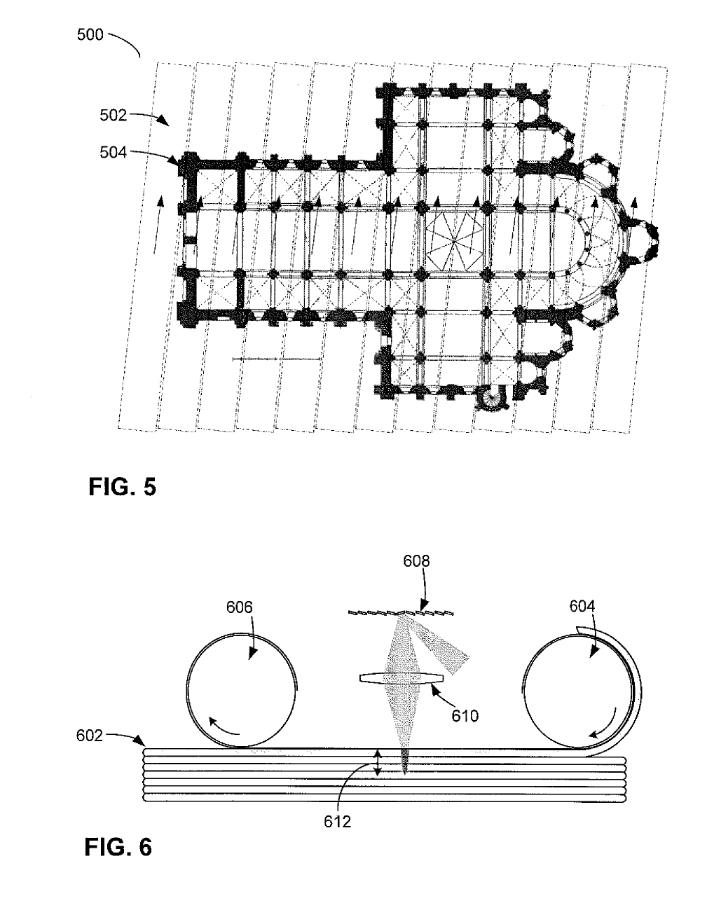

FIG. 5 shows a part being printed in a series of adjacent passes separated by a gap using a photo-curable resin. Here, a layer or slice of a part is shown in the x-y plane, printed using a series of non-overlapping paths that have a gap between each path. More specifically, a series of paths 502 are printed adjacent to one another to print a part 504, but the paths do not overlap or touch one another. This results in a narrow area of uncured or under-cured resin separating each path from the adjacent path, resulting in a printed layer having weak or uncured gaps between paths.

Some embodiments therefore seek to remedy problems such as these, such as by providing offset gaps between paths used to form successive layers in a part printed using a 3D printer. One such embodiment, the gap formed between passes 502 in printing part 504 in FIG. 5 are positioned differently or offset from the gaps in the prior layer or layers, resulting in staggering or offsetting gaps in different layers of the part.

Because the offset gaps in adjacent or near-adjacent layers of part 504 do not line up in the z-axis with one another, the gaps between passes do not stack in the z-axis to form a large, continuous gap. This enables part layers above and below the gap to support the gap, thereby resulting in a strong and stable part.

Although the gap in FIG. 5 is illustrated as a straight line gap, the gap will take other forms in further embodiments, such as a wavy or zig-zag line, follow a randomized path, or otherwise deviate from straight. The line pattern or path can in such embodiments also vary between layers, such as offsetting a zig-zag or wavy gap so that the gap pattern does not align between layers, further reducing the chances of a weakness forming along a gap line between paths. The varying line pattern may further be generated by optically varying the gap by varying the image provided via the projector apparatus rather than by mechanically varying the path of the projector apparatus, avoiding resonances and other complications related to extra movement to generate a varying gap shape.

Offsetting the gap between paths from layer to layer also enables the uncured material in a gap an opportunity to be exposed to resin material during printing of subsequent layers, and for resin material in the gap that is uncured or that has migrated from an above layer to be exposed to ultraviolet or other curing light such as from the projector apparatus 210 of FIG. 2. This provides additional opportunity for the gap to be filled or minimized, particularly in embodiments where the layer thickness is very small. For example, some embodiments use resin layers that are only tens of microns in thickness (e.g. 25 or 50 microns), enabling very high part resolution even when small gaps between passes are not initially fully cured but are offset.

FIG. 6 shows optical curing of photopolymer layers forming a 3D part. Here a series of layers of photopolymer 602 are deposited by a first roller 604 on a backing material, overlaying new photopolymer on previous layers of the part being printed. The photopolymer is exposed to curing light projected by a digital micromirror device 608 and projection lens 610 to selectively form a light pattern corresponding to a desired part shape for the layer or slice being printed. The projected light image in this embodiment penetrates more than one layer of the photopolymer as shown at 612, such that it still provides an attenuated curing effect to uncured polymer for at least one layer below the top layer being cured. A gap in the layer immediately below the top layer will therefore have at least one additional chance to be cured if the polymer immediately above the gap is cured to form the part, thereby at least partially curing the uncured resin in the gap.

Because the projected light will at least partially cure layers of resin below the top layer, it is desired that the layers of resin be smaller than the desired resolution of the part in the z-axis, or perpendicular to the plane of the deposited resin. This ensures that light curing layers below the current layer will not cause deformities in the part, such as curing lower layers of resin that are not intended to be cured. But, it is desirable that the curing light penetrates at least the top layer of resin, to ensure the resin layer is cured through its entirety and bonds to the part below. In the embodiment illustrated in FIG. 6, the curing light penetrates up to three layers of resin, and so the resin layers are selected to be a third or less the desired part tolerance or resolution. By selecting a resin layer thickness less than half the desired resolution of the part, each part feature will be printed or cured in at least two consecutive layers or slices.

When the resin layers 602 are very thin, such as a fraction of the intended printing resolution of the part, minor gaps between printing passes in a single layer such as may exist at the surface of a part are not consequential, as they do not exceed the desired part tolerance and will be difficult to perceive. Offset gaps not at a top surface of the part will be cured during printing of subsequent layers, as curing light for the layers immediately following the offset gap will filter through top resin layers to the gap and at least partially cure the resin in the offset gap.

By offsetting gaps, the 3D print system ensures that no gap between printing passes will stack vertically or match in the z-axis with additional gaps at the same location, forming a permanent gap, but instead will be cured by subsequent offset printing and curing of layers or slices that make up the part.

The gap between passes is offset layer to layer in various embodiments by offsetting the position of the projector assembly that projects curing light onto the resin material, by projecting the gap by changing illumination at the edges of the projected image to form a gap that can be positioned as part of projecting the image, or both. Selectively projecting a gap using the curing light projector further enables the gap to vary somewhat where beneficial, such as to form a zig-zag or wavy pattern to avoid a straight line that may form a shear plane, or to avoid being positioned near edges of printed parts.

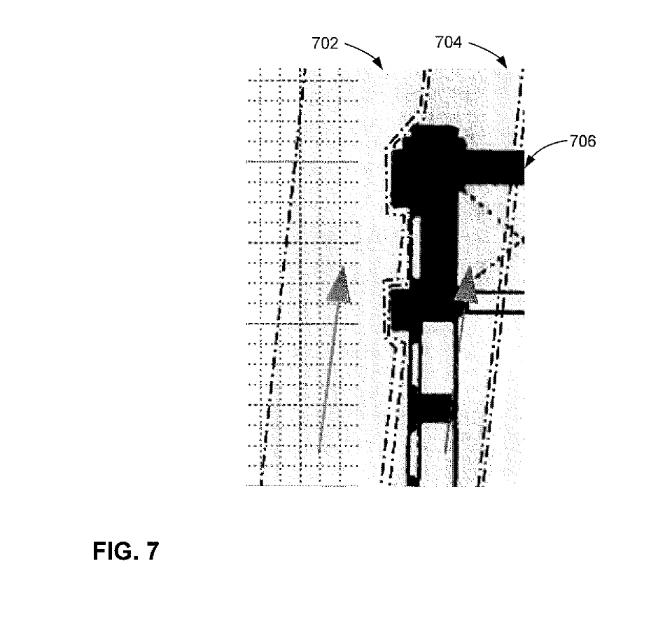

FIG. 7 shows selection of a gap position between adjacent passes to avoid a part. Here, a first pass 702 varies the position of a gap calculated to be formed between passes 702 and 704 to avoid printing a small corner of a part 706, thereby allowing pass 704 to print the entire corner of the part without the gap between passes leaving a small corner of the part unattached to the part in the layer being printed. This results in a stronger part 706, as gaps between passes near edges of the part are avoided when possible. Further, a person's eye can be very sensitive to part surface imperfections of some types. Printing cosmetically significant regions of a part within a single swath can improve the appearance of such surfaces, resulting in a more aesthetically pleasing part.

The gap between passes 702 and 704 can be avoided here because the projector that projects the curing light image onto the resin is not using 100% of its resolution perpendicular to the path direction to project the image. This enables the 3D printer to selectively use this unused width to print a part that is near a planned gap, such as the gap between paths 702 and 704, to avoid printing a gap near an edge or corner of the part. In FIG. 7, the projector has enough unused pixels available in pass 704 to print parts of 706 that would otherwise be printed in pass 702, enabling the part 706 to be printed with no gap near the edge of part 706

The ability of the 3D printer to avoid printing a gap near a narrow section or corner of a part in such embodiments is therefore dependent in part on unused pixels at the edge of each printing pass 702 and 704. In other embodiments neighboring paths are shifted, such as where path 704 is shifted to the left sufficiently to enable the printer to print the sections of part 706 that would otherwise have been printed in pass 702. This method of shifting paths is somewhat more complex, but may be desired in some applications as it does not involve leaving unused pixels near each edge of each printed path, thereby providing increased speed and fewer passes to print each layer.

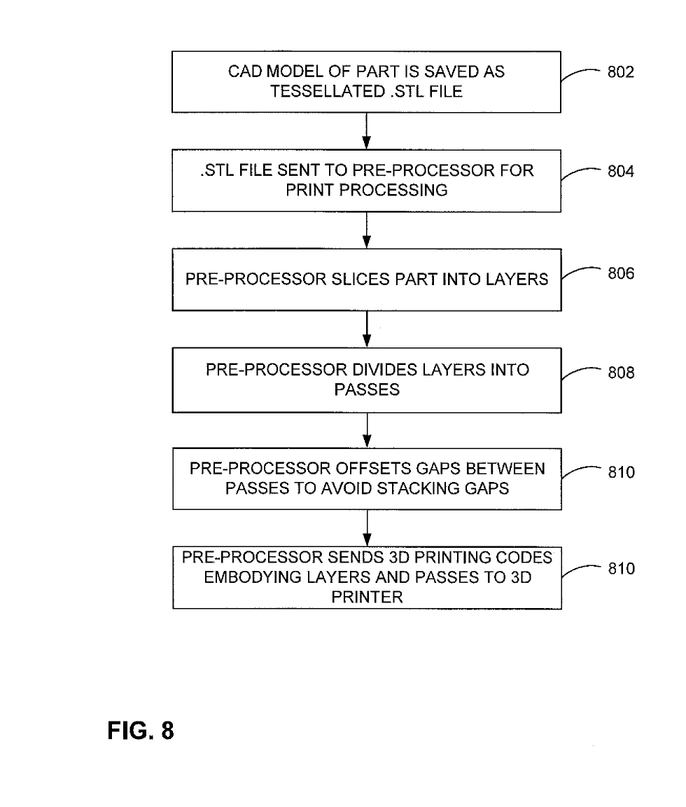

FIG. 8 is a flowchart illustrating a method of printing a 3D part using offset gaps. At 802, a Computer-Aided Design model of the part is generated, and is saved as a .STL file or other suitable file format that contains a model representing the part in three dimensions. The .STL file in this embodiment differs from many CAD formats in that the model of the part is tessellated, or made up of a number of triangles or other polygons representing the surfaces of the part rather than continuous, vector-based models common in other CAD applications. The .STL file is therefore typically created with a maximum chordal tolerance or deviation between the vector model and the tessellated model, as well as an angular deviation allowed between triangles or polygons in modeling a smooth surface (such as a tight radius curve). Other features, such as holes and gaps, are checked against 3D printing capabilities so that problematic features can be identified and fixed before printing.

The .STL file is sent to a pre-processor at 804. The pre-processor in this embodiment converts the model in the .STL file into tool paths the printer will use to print the 3D part, and in further embodiments includes functionality to scale a model, position models of multiple parts to be printed at the same time, and perform other such functions. The pre-processor in this embodiment has knowledge of the 3D printer configuration to perform these functions, such as the depth of each layer, the optical resolution of the projection assembly that projects the UV curing light, the size of the work space, and the width of each pass used to print a layer.

The pre-processor uses the .STL model of the part and information regarding the 3D printer to slice the model into layers at 806, which in some embodiments are thinner than the desired resolution of the printed part. For example, the layers may be ½ to ⅕ the desired resolution of the part, and may be as thin as tens of microns (e.g. 10-99 microns) using some technologies such as that shown in FIG. 6. The layers are then divided into passes of the projection assembly at 808, such as are shown in FIGS. 3-5. The passes in some embodiments are determined such that gaps between passes are offset between sequential layers to avoid stacking gaps, while in other embodiments the passes are created first and are then altered to avoid gaps that stack vertically between sequential layers, as shown at 810. In a further embodiment, the gaps between passes are calculated to avoid having a gap pass within a certain distance of the edge of a part, to avoid having a gap separate a small piece or corner of a part from the rest of the part, or otherwise positioned to avoid unnecessarily positioning gaps through the part where it can be avoided, as shown and described in FIG. 7.

Once the pre-processor has completed processing the .STL model of the part to create tool paths and other information to be sent to the 3D printer, the tool paths and other information embodying the calculated layers and passes that will make up the part are sent to the printer at 810. This is achieved in some embodiments by using driver software, much like a print driver, to send instructions to the printer using commands the printer understands. In other embodiments, the data stream sent to the 3D printer will resemble video, which may be more easily processed and projected using a projector assembly such as that of FIG. 2.

The 3D printer is connected to a computerized system running the pre-processor and other software in the embodiment of FIG. 8, but in other embodiments various functions will be added, omitted, or performed by elements other than those illustrated here. In one such embodiment, a printer is operable to receive an .STL file directly, and a pre-processor within the 3D printer is operable to generate layers, passes, and to perform other functions needed to print a part from the .STL model.

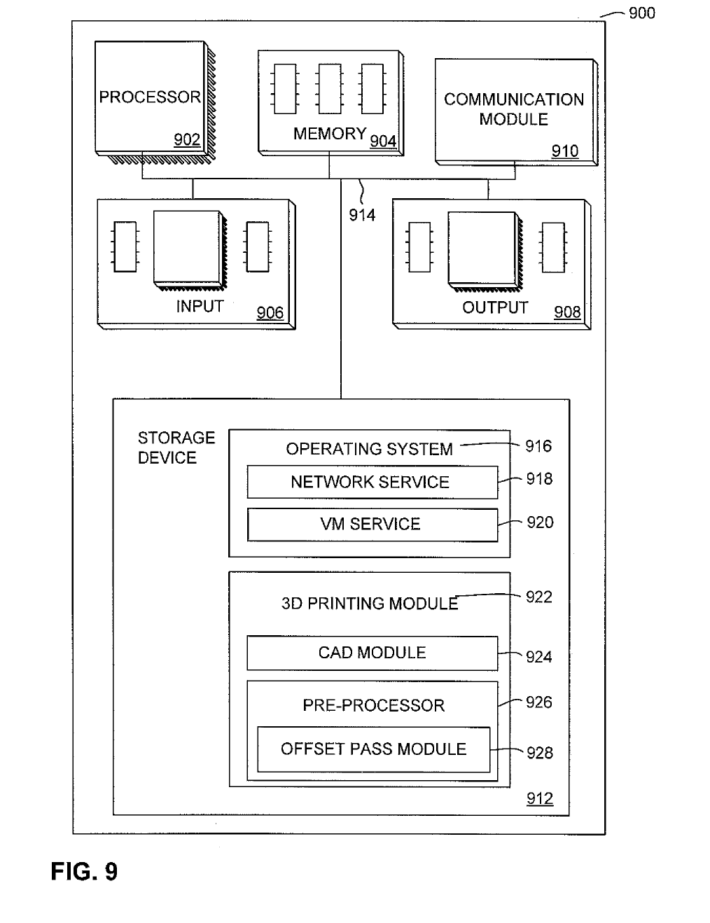

FIG. 9 is a computerized 3D printing system using offset gaps. FIG. 9 illustrates only one particular example of computing device 900, and other computing devices 900 may be used in other embodiments. Although computing device 900 is shown as a standalone computing device, computing device 900 may be any component or system that includes one or more processors or another suitable computing environment for executing software instructions in other embodiments, and need not include all of the elements shown here.

As shown in the specific embodiment of FIG. 9, computing device 500 includes one or more processors 902, memory 904, one or more input devices 906, one or more output devices 908, one or more communication modules 910, and one or more storage devices 912. Computing device 900 further includes an operating system 916 executable by computing device 900. The operating system in various embodiments includes services such as a network service 918 and a virtual machine service 920 such as a virtual server. One or more applications, such as recommendation module 922 are also stored on storage device 912, and are executable by computing device 900.

Each of components 902, 904, 906, 908, 510, and 912 may be interconnected (physically, communicatively, and/or operatively) for inter-component communications, such as via one or more communications channels 914. In some embodiments, communication channels 914 include a system bus, network connection, inter-processor communication network, or any other channel for communicating data. Applications such as recommendation module 922 and operating system 916 may also communicate information with one another as well as with other components in computing device 900.

Processors 902 are configured to implement functionality and/or process instructions for execution within computing device 900. For example, processors 902 may be capable of processing instructions stored in storage device 912 or memory 904. Examples of processors 902 include any one or more of a microprocessor, a controller, a digital signal processor (DSP), an application specific integrated circuit (ASIC), a field-programmable gate array (FPGA), or similar discrete or integrated logic circuitry.

One or more storage devices 912 may be configured to store information within computing device 900 during operation. Storage device 912, in some embodiments, is known as a computer-readable storage medium. In some embodiments, storage device 912 comprises temporary memory, meaning that a primary purpose of storage device 912 is not long-term storage. Storage device 912 may be a volatile memory, meaning that storage device 912 does not maintain stored contents when computing device 900 is turned off. In other embodiments, data is loaded from storage device 912 into memory 904 during operation. Examples of volatile memories include random access memories (RAM), dynamic random access memories (DRAM), static random access memories (SRAM), and other forms of volatile memories known in the art. In some embodiments, storage device 912 is used to store program instructions for execution by processors 902. Storage device 912 and memory 904, in various embodiments, are used by software or applications running on computing device 900 such as 3D printing module 922 to temporarily store information during program execution.

Storage device 912, in some embodiments, includes one or more computer-readable storage media that may be configured to store larger amounts of information than volatile memory. Storage device 912 may further be configured for long-term storage of information. In some embodiments, storage devices 912 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 900, in some embodiments, also includes one or more communication modules 910. Computing device 900 in one embodiment uses communication module 910 to communicate with external devices via one or more networks, such as one or more wireless networks. Communication module 910 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communications (NFC), and Universal Serial Bus (USB). In some embodiments, computing device 900 uses communication module 910 to wirelessly communicate with an external device such as via public network such as Internet.

Computing device 900 also includes in one embodiment one or more input devices 906. Input device 906, in some embodiments, is configured to receive input from a user through tactile, audio, or video input. Examples of input device 906 include a touchscreen display, a mouse, a keyboard, a voice responsive system, video camera, microphone or any other type of device for detecting input from a user.

One or more output devices 908 may also be included in computing device 900. Output device 908, in some embodiments, is configured to provide output to a user using tactile, audio, or video stimuli. Output device 908, in one embodiment, includes a display, a sound card, a video graphics adapter card, or any other type of device for converting a signal into an appropriate form understandable to humans or machines. Additional examples of output device 908 include a speaker, a light-emitting diode (LED) display, a liquid crystal display (LCD), or any other type of device that can generate output to a user.

Computing device 900 may include operating system 916. Operating system 916, in some embodiments, controls the operation of components of computing device 900, and provides an interface from various applications such as 3D printing module 922 to components of computing device 900. For example, operating system 916, in one embodiment, facilitates the communication of various applications such as 3D printing module 922 with processors 502, communication unit 910, storage device 912, input device 906, and output device 908. Applications such as 3D printing module 922 may include program instructions and/or data that are executable by computing device 900. As one example, 3D printing module 922 and its Computer-Aided Design (CAD) module 924, pre-processor 926, and offset pass module 928 may include instructions that cause computing device 900 to perform one or more of the operations and actions described in the embodiments presented herein, such as by directing a 3D printer to perform certain operations.

Although specific embodiments have been illustrated and described herein, any arrangement that achieve the same purpose, structure, or function may be substituted for the specific embodiments shown. This application is intended to cover any adaptations or variations of the exemplary embodiments of the invention described herein. These and other embodiments are within the scope of the following claims and their equivalents.

1. A method of printing a three-dimensional part, comprising:
dividing each of a plurality of layers of a model of the three-dimensional part into a plurality of passes, each of the plurality of passes being separated from one or more adjacent passes by a gap between the passes; and
offsetting the gap between passes in a first layer from the gap between passes in an adjacent layer of the plurality of layers, such that the gap between passes in the first layer does not align with or stack with the gap between passes in the adjacent layer.

2. The method of printing a three-dimensional part of claim 1, further comprising dividing the model of the three-dimensional part into a plurality of layers that when stacked adjacent to one another form the three-dimensional part.

3. The method of printing a three-dimensional part of claim 1, further comprising printing the three-dimensional part by operating a projector to expose an ultraviolet light-curable resin in a plurality of paths to form each of the plurality of layers of the model of the three-dimensional part.

4. The method of printing a three-dimensional part of claim 1, wherein offsetting the gap between passes comprises shifting a position of a projector that prints the passes on adjacent layers.

5. The method of printing a three-dimensional part of claim 1, wherein offsetting the gap between passes comprises varying which pixels of a projector are used to print passes on adjacent layers of the part, such that unused pixels at edge of a projected image used to print passes on adjacent layers vary from layer to layer.

6. The method of printing a three-dimensional part of claim 1, further comprising printing each of the plurality of passes and layers by projecting a curing light image via a projector assembly, the curing light image being projected through at least part of a top layer and a layer adjacent to the top layer.

7. The method of printing a three-dimensional part of claim 1, wherein the layers comprise layers printed using a photo-curable resin, wherein the photo-curable resin in one or more offset gaps is cured by exposing the one or more offset gaps to curing light through a printed layer between the one or more offset gaps and the curing light.

8. The method of printing a three-dimensional part of claim 1, wherein offsetting the gap between passes further comprises avoiding printing a gap near an edge of the part.

9. The method of printing a three-dimensional part of claim 1, wherein offsetting the gap between passes occurs in a preprocessor.

10. The method of printing a three-dimensional part of claim 1, wherein offsetting the gap between passes occurs in a 3D printer.

11. The method of printing a three-dimensional part of claim 1, further comprising applying a photopolymer or resin via a transport film rolled onto the part to form each layer.

12. A three-dimensional printer controller, comprising:
a processor configured to divide each of a plurality of layers of a model of the three-dimensional part into a plurality of passes, each of the plurality of passes being separated from one or more adjacent passes by a gap between the passes, the processor further configured to offset the gap between passes in a first layer from the gap between passes in an adjacent layer of the plurality of layers, such that the gap between passes in the first layer does not align with or stack with the gap between passes in the adjacent layer.

13. The three-dimensional printer controller of claim 12, wherein offsetting the gap between passes comprises shifting the position of a projector that prints the passes on adjacent layers.

14. The three-dimensional printer controller of claim 12, wherein offsetting the gap between passes comprises varying which pixels of a projector are used to print passes on adjacent layers of the three-dimensional part, such that unused pixels at edge of a projected image used to print passes on adjacent layers vary from layer to layer.

15. The three-dimensional printer controller of claim 12, further comprising printing each of the plurality of passes and layers by projecting a curing light image via a projector assembly, the curing light image projected through at least part of a top layer and a layer adjacent to the top layer.

16. The three-dimensional printer controller of claim 12, wherein the layers comprise a layers printed using photo-curable resin, wherein the photo-curable resin in one or more offset gaps is cured by exposing the one or more offset gaps to curing light through a layer between the one or more offset gaps and the curing light.

17. The three-dimensional printer controller of claim 12, wherein offsetting the gap between passes further comprises avoiding printing a gap near an edge of the three-dimensional part.

18. The three-dimensional printer controller of claim 12, further comprising applying a photopolymer or resin via a transport film rolled onto the three-dimensional part to form each layer.

19. A machine-readable medium with instructions stored thereon, the instructions when executed operable to cause a computerized system to:
divide each of a plurality of layers of a model of the three-dimensional part into a plurality of passes, each of the plurality of passes being separated from one or more adjacent passes by a gap between the passes; and
offset the gap between passes in a first layer from the gap between passes in an adjacent layer of the plurality of layers, such that the gap between passes in the first layer does not align with or stack with the gap between passes in the adjacent layer.

20. The machine-readable medium of claim 19, the instructions when executed further operable to cause the computerized system to print each of the plurality of passes and layers by projecting a curing light image via a projector assembly, the curing light image projected through at least part of a top layer and a layer adjacent to the top layer.
